(19) United States
(12) Patent Application Publication
(10) Pub. No.: US 2007/0045397 A1
(43) Pub. Date: Mar. 1, 2007

(54) Flexible, multi-mode financial transactions processing systems and methods

(75) Inventors: Philip Michael William Ireland, Rowlands Castle (GB); John W. Smith, Woodridge, IL (US)

Correspondence Address: OLIFF & BERRIDGE, PLC, P.O. BOX 19928, ALEXANDRIA, VA, 22320, US

(73) Assignee: DE LA RUE INTERNATIONAL, LIMITED, HAMPSHIRE (GB)

(21) Appl. No.: 11/505,882

(22) Filed: Aug. 18, 2006

Related U.S. Application Data
(60) Provisional application No. 60/710,142, filed on Aug. 23, 2005.

(51) Int. Cl. G07F 19/00; G06F 7/08

(52) U.S. Cl. 235/379; 235/381

(57) ABSTRACT

A financial transactions processing system is operable in more than one mode so that it can have increased usefulness to the bank. Such a system can be switched between the available modes as desired by the bank so that separate, dedicated machines for operation in a single one of the different modes are not necessary.

This Nonprovisional application claims the benefit of U.S. Provisional Application No. 60/710,142, filed Aug. 23, 2005.

### BACKGROUND

The inventions described herein relate to financial transactions processing systems and methods that can be used, for example, in banks and other financial institutions or environments.

A typical bank branch office includes a teller counter having one or more teller stations. The teller counter typically separates the branch office into a teller area on one side of the counter, and a customer area on the other side of the counter. In some banks, an additional transparent (possibly bullet-proof) partition is located above the counter to further separate the teller area from the customer area. Each teller station typically includes a teller display monitor that faces the teller, and thus can be viewed only by the teller. When a customer makes a transaction with a teller at one of the teller stations, the teller enters the customer information (for example, the customer's account number) into a teller computer that communicates with a bank computer, and then information about the customer's account can be displayed to the teller over the teller display monitor.

Because the teller display faces the teller, and the teller and customer are separated by the teller counter (possibly including the additional transparent partition), the customer cannot view the information on the teller display. The inability of the customer to view the teller display can be inconvenient, for example, when the teller seeks to confirm the correctness of the information on the display, or when the customer desires access to the information on the display, for example, the account balance in the customer's account. To provide the customer with the customer's account balance, the teller typically must write this information on a slip of paper that is then given to the customer.

A more recent trend in the banking industry is to provide stand-alone podiums (sometimes called towers) containing one or two teller stations around which tellers and customers can move. Examples of such stand-alone podiums/towers are provided in, for example, U.S. Pat. No. 6,681,985, the disclosure of which is incorporated herein by reference in its entirety. Also see De La Rue Cash Systems GMBH and Plan Object GMBH “Dialog Banking in der Praxis”, Mörfelden-Walldorf, February, 1999. These stand-alone podiums also, however, include a display only for the teller (podiums/towers with two teller stations include a teller display for each of the tellers). If the teller display is built into the podium, then the customer needs to move to the teller's side of the podium in order to view the display. If the display rests on top of the podium, then the teller may be able to move the display so that the customer can view the display, or again, the customer can move to the teller's side. However, either of these procedures is inconvenient. In addition, because the teller's display screen sometimes includes information that is not intended for viewing by the customer (for example, alerts regarding the customer or the customer's account), the teller may not want the customer to view the teller's display. However, in such a situation, it may be difficult for the teller to prevent the customer from viewing the teller's display in the stand-alone podium/tower environment.

Many bank branch offices also include self-service devices (for example, an ATM) where a customer may transact certain types of bank business without the intervention of a bank teller. However, not all banking business may be transacted on these self-service devices. Thus, most financial institutions use a combination of both teller and self-service devices. Although the self-service and teller-assist devices are not identical, they have many components that perform similar functions. Thus, the provision of multiple different devices leads to unnecessary product duplication, additional investment by the bank in such devices, and sub-optimal management of cash (because small amounts of cash are located in many devices).

Many banks use cash dispensing devices to assist tellers. These devices contain a store of cash (e.g., notes) contained in a safe area, and have a dispensing mechanism to dispense notes to the teller. Such a device will hereafter be referred to as a TCD (teller cash dispenser). The TCD typically is coupled to and controlled by a computer (e.g., the teller's computer) to dispense cash according to instructions input by the teller. For example, if a customer wishes to withdraw $300 from the customer's account, once the teller approves the transaction, the teller instructs the TCD to dispense $300 (either according to a predetermined mix of denominations or according to a teller-specified mix of denominations). The TCD then dispenses the money to the teller, who hands the money to the customer. One example of a teller cash dispenser is the TCD 2000, Model 50, Model 30, etc., or the Benchmark Series® 7 teller cash dispensing system, all provided by De La Rue Cash Systems of Lisle, Ill.

A TCD does not have the capability of counting money that is deposited, but may include a secure drop box into which bundles of cash, for example (perhaps placed in a marked envelope), can be inserted.

As an alternative to a TCD, a teller cash recycler (TCR) can be provided. A TCR is similar to a TCD, except that the TCR also has an input bin into which a stack of currency bills can be placed, and hardware and software for feeding the bills from the input bin, scanning the bills to determine their denomination and/or authenticity (by using, for example, one or more of optical, magnetic and UV sensing techniques well known in the art), and then feeding denominated and/or authenticated notes to currency storing cartridges located within the machine. The notes then can be re-dispensed from the currency storage cartridges. Thus, when the device is a TCR, the currency bill storage cartridges must be capable of receiving bills and then re-dispensing such bills. For a TCR, the currency bill storage cartridges typically are roll storage modules (RSM), whereas a TCD, which only needs to dispense currency bills, can use other types of bill storage cartridges, for example, which store the bills in a stack. Some examples are shown in, for example, U.S. Pat. No. 6,373,209, U.S. Pat. No. 6,715,735, U.S. Pat. No. 6,557,849 and WO 03/075228.

While some banks place the TCD or TCR in a back office, a more convenient location is to place the TCD or TCR in the teller area such that multiple tellers can access the machine. It also is known to incorporate a TCD or TCR under the teller counter, for example, between two teller stations so that two tellers can share one TCD or TCR.

The teller podiums/towers described above also can include a TCD therein in order to dispense currency to the teller or directly to the customer. A TCR also could be placed in a teller podium/tower.

From the above description, it may be appreciated that a bank may have multiple cash dispensing machines, each of which is tailored for a particular use such as, for example, behind or under the teller counter for dispensing cash to a teller or to a customer, incorporation into a teller podium/tower for dispensing cash to a teller or directly to a customer, and/or an ATM that is a self-service device.

The usage of these various devices varies depending on numerous factors such as the time of day, the number of available tellers, and the number of customers in the bank. For example, the ATM may be used primarily after normal banking hours or when the teller-operated counters are busy. Thus, the ATM may be idle for certain portions of the day.

Conversely, during the evening when the bank is closed, the bank may wish that it could provide more ATMs to increase after-hour usage.

In addition, depending on the customer's needs, a customer may require teller assistance, which cannot be provided with an ATM. Thus, the bank may wish that it could use the cash located in an idle ATM to service a customer, with the needed assistance of a teller.

Thus, a bank may be compelled to purchase various different types of machines, even though some of those machines remain idle during portions of the day, while customers may need to wait in line at other machines that are suitable for meeting the customer's needs.

### SUMMARY

According to some aspects of the invention, a financial transactions processing system is operable in more than one mode so that it can have increased usefulness to the bank. Such a system can be switched between the available modes as required by the bank so that separate, dedicated machines for operating in a single one of the different modes are not necessary.

### BRIEF DESCRIPTION OF THE DRAWINGS

Various embodiments of the inventions will be described in detail with reference to the following drawings in which like reference numerals are used to identify like elements, and wherein:

FIG. 1 is a block diagram of a financial transactions processing system according to an embodiment of the invention;

FIG. 2 is a schematic diagram of a multi-mode financial transactions processing system having two display screens according to an embodiment of the invention;

FIG. 3 is a schematic diagram of a multi-mode financial transactions processing system having a single display screen according to another embodiment of the invention;

FIG. 4 is a schematic diagram of the FIG. 3 system with the display screen facing in the opposite direction of FIG. 3;

FIG. 5 shows a proximity sensor included on the system of FIGS. 3 and 4;

FIG. 6 is a side view of a dual station teller podium/tower with the displays omitted;

FIG. 7 is a top view of the FIG. 6 dual station teller podium/tower;

FIG. 8 is a perspective view of a teller counter that includes financial transactions systems according to embodiments of the invention;

FIG. 9 shows an example of a customer display screen;

FIG. 10 shows an example of a teller display screen;

FIG. 11 is a display screen that can be displayed to a customer over a customer display;

FIG. 12 shows display screens that can be displayed when in the self-service with teller-assist mode;

FIG. 13 illustrates examples of the time of day in which a machine can operate in the respective different modes;

FIG. 14 shows a machine with a retractable display screen; and

FIG. 15 illustrates a TCR that uses an extra cassette in order to perform a replenishment operation to add notes to one or more of its Role Storage Modules and/or to perform a skimming operation to withdraw notes from one or more of its Roll Storage Modules.

### DETAILED DESCRIPTION OF EXEMPLARY EMBODIMENTS

Exemplary embodiments will be described with reference to the accompanying drawings. These embodiments, however, are exemplary only, and are not intended to limit the invention.

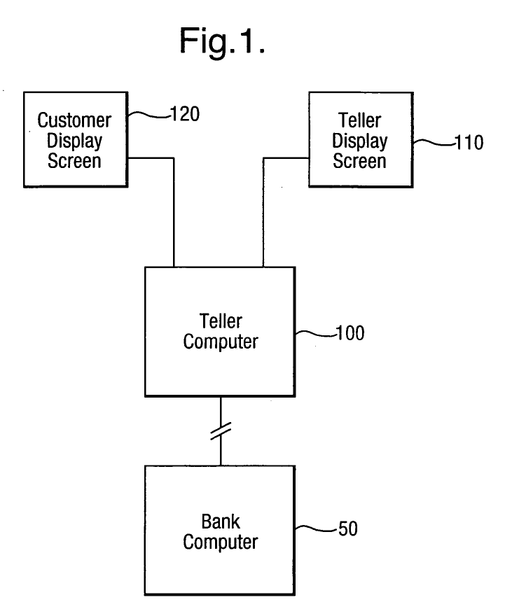

As shown in FIG. 1, a teller station includes a teller computer 100 that can be linked to a bank computer 50 over a communications system such as an intranet or the Internet. A secure wireless communication link also is possible. The teller computer 100 can be, for example, a personal computer running appropriate banking software. One example of appropriate banking software is Teller Cash Connect, available from De La Rue Cash Systems of Lisle, Ill.

According to this embodiment, each teller station also includes a teller display screen 110 and a customer display screen 120. As described later in connection with other embodiments, it is possible to practice aspects of the invention with a single display screen. Typically, the size (area) of the teller display screen will be larger than the size (area) of the customer display screen. For example, the teller display screen can be a 19 inch monitor, whereas the customer display screen can be a 15 inch monitor. However, in order to provide the most flexibility, both display screens can have the same size, for example, by being a 17 inch monitor. In general, the display screens are in the range of 15-21 inch monitors.

In addition, according to some embodiments, one or both of the display screens (or the single display screen for the single display screen embodiments) includes a touch panel (the display screen and touch panel collectively forming a touch screen) so that the display screen(s) can function as a user interface. As is known, the touch panel typically includes a two-dimensional matrix of optically transparent switches. Examples of touch screens are provided in U.S. Pat. Nos. 6,665,431, 5,317,140,5,297,030, 5,231,381, 5,198,976,5,184,115, 5,105,186,4,931,782, 4,928,094, 4,851,616, 4,811,004, 4,806,709 and 4,782,328, the disclosures of which are incorporated herein by reference in their entireties.

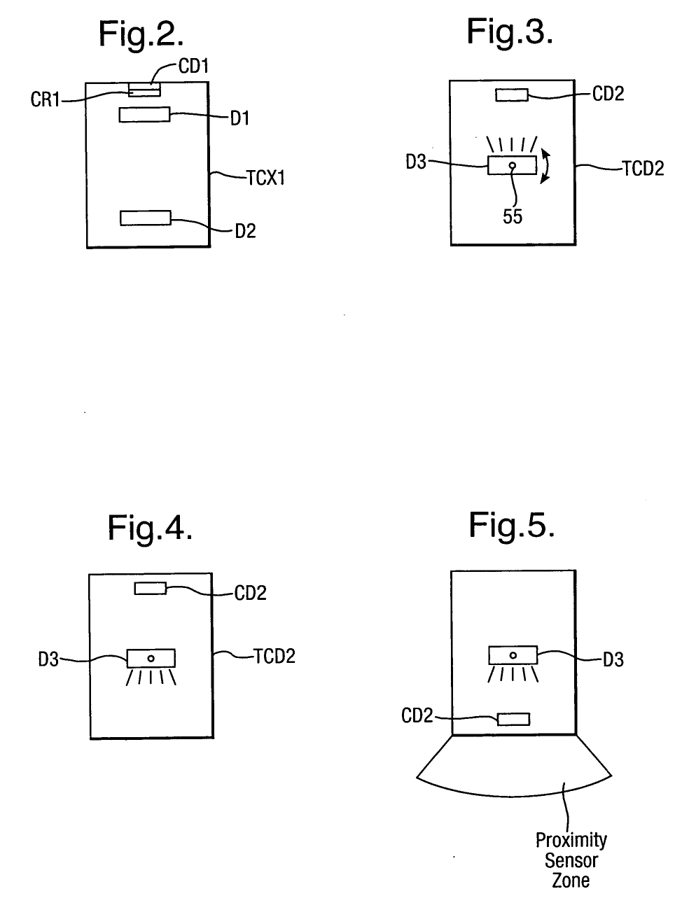

FIG. 2 schematically shows a financial transactions processing system according to one embodiment of the invention. This system can be located, for example, in a teller counter or in a teller podium/tower. The system includes a teller cash dispensing machine labeled TCX1. This machine can be a TCR or a TCD. In the illustrated example, the machine TCX1 is a TCR having a cash dispensing portion CD1 and a cash receiving portion CR1. The machine also has a first display D1 and a second display D2. The displays face in opposite directions such that a person located at one end of the machine (adjacent to the cash dispenser CD1) can view screen D1, whereas a person located at the other end of the machine can view display D2.

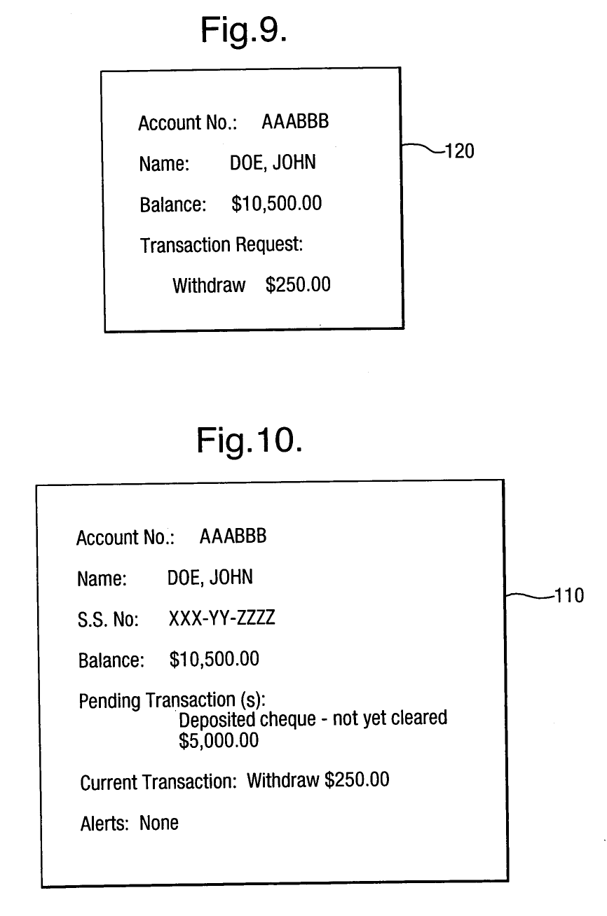

The machine and the controller (for example, including a CPU that may be part of a teller computer, a bank computer, or a computer dedicated for the particular machine TCX1) that controls the machine are configured such that display D1 could be a teller display or a customer display, and similarly display D2 could be a teller display or a customer display. When display D1 is a teller display, then display D2 is a customer display. Conversely, when display D1 is a customer display, then display D2 is a teller display. The content (information) displayed on a teller display typically would differ from the content (information) displayed on a customer display. Usually less information is provided on the customer display. FIG. 9 shows one example of a customer display, and FIG. 10 shows one example of a teller display for the same transaction. In addition, the customer display can display general promotional material when the machine is not being used by a customer.

For example, the customer display could display the customer's name and account number along with the transaction request (e.g., to withdraw or deposit a specified amount). The customer display also could display the balance in the customer's account. Promotional material also could be displayed on the customer display. This promotional material could be specifically tailored to the customer, or it could be general promotional material. The teller display could display information about the customer's account (name, number and account balance), the transaction request, and alerts, for example, that the amount requested requires manager approval or that the amount requested is beyond the account balance. Such alerts are not provided on the customer display. The teller display also could provide messages that prompt the teller to ask the customer if the customer is interested in various products available from the bank.

When display D1 is the teller display and display D2 is the customer display, then the system TCX1 functions as a teller station in which cash is dispensed to (for a withdrawal) and received from (for a deposit) the teller. In such a mode of operation, a customer would present cash, checks, etc., to the teller when making a deposit. The teller would place the cash into the cash receptacle CR1, and then the machine would denominate and count the notes and store those notes in the machine. Assuming that the total cash counted agrees with the amount the customer believed that the customer was depositing, the teller would accept the transaction, for example, by pressing a button, and then the notes would remain in the storage receptacles of the machine. If the teller (based on instructions from the customer) does not accept the deposit, then the notes would be re-dispensed from the machine for re-counting or other appropriate handling. If checks were deposited, the amount of the check could be manually input by the teller, or the system could include a check scanning component that scans checks to determine their amount, as is known in the art. One possible check scanning device is the TellerScan 350 (TS-350) offered by Data Financial Business Services, Inc. If coins are deposited, the total coin deposit amount could be input manually by the teller or a coin counting component could be provided with the machine in order to automate the coin counting process. Possible coin counting and sorting products include the De La Rue Mach 3, 6, 9 and 12 range of products.

Although it is not necessary for the customer to have a display during this mode of operation, providing a display to the customer can enhance the banking experience by enabling the customer to monitor the deposit process. For example, the customer display (display D2 in this mode) could provide the customer with the various amounts counted by the system and/or input by the teller. Other information, such as the customer's account balance, etc., also can be provided. In addition, promotional information, such as available loans, etc., can be displayed over the customer display D2 during use or when the system is not being used by any customer.

A recent trend in the banking industry is to have automated machines dispense money directly to the customer, rather than to the teller for handing to the customer. If the bank desired to operate the system TCX1 in such a mode, then the controller could control the machine such that display D1 is the customer display, whereas display D2 is the teller display. In this second mode of operation, the system TCX1 functions as a teller station that dispenses directly to the customer. In this mode, deposits could be handled by having the customer insert the money into the cash receptacle CR1. However, customers may prefer that the teller perform this function. In addition, if the system TCX1 is a TCD (rather than a TCR), then the system only dispenses notes, and therefore the teller would process a deposit in the usual manner. This would include, for example, the teller counting the notes and coins and/or totaling up the checks and then entering that information into the bank's computer system. Again, the customer display D1 could provide the customer with such information so that the customer is confident that the transaction is being processed correctly. The teller would then place the deposited currency media (checks, notes, coins) in a drop box provided in the TCD or in a separate cash drawer.

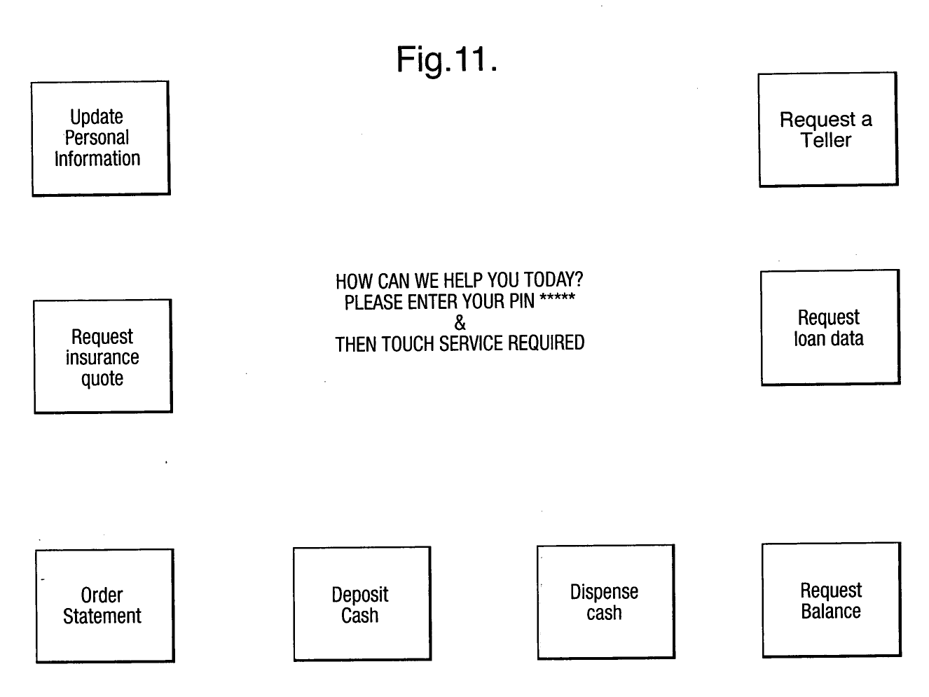

The system TCX1 also can be operated in a self-service mode. In this third mode, display D1 is operative and used by a customer in order to withdraw and/or deposit using cash dispensing portion CD1 and cash receiving portion CR1. As an alternative to using cash receiving portion CR1, for example, if system TCX1 is a TCD, a drop box could be provided into which the customer could place an envelope containing the deposit. The display D2 is disabled and not used in this mode. In this mode, the machine TCX1 functions like an ATM. FIG. 11 shows one example of a screen that can be provided to the customer in this third (self-service) mode.

In a fourth mode, the machine TCX1 functions as a self-service device with teller assist. This mode is similar to the third mode (i.e., only display D1 is used), except that the teller can access functions using display D1 to assist the customer. For example, if the customer desired assistance from a teller, the teller could stand shoulder-to-shoulder with the customer in front of display D1. The display could include a button (e.g., a touch screen button) by which the teller could access the system, and then the teller could provide assistance to the customer. After the teller presses the button, for example, the teller could be asked to input a password or PIN that enables the teller to call up various functions to enable the teller to assist the customer in the desired transaction. Alternatively, the teller could gain access by swiping an ID card of the teller in a card-swipe slot provided on the system TCX1.

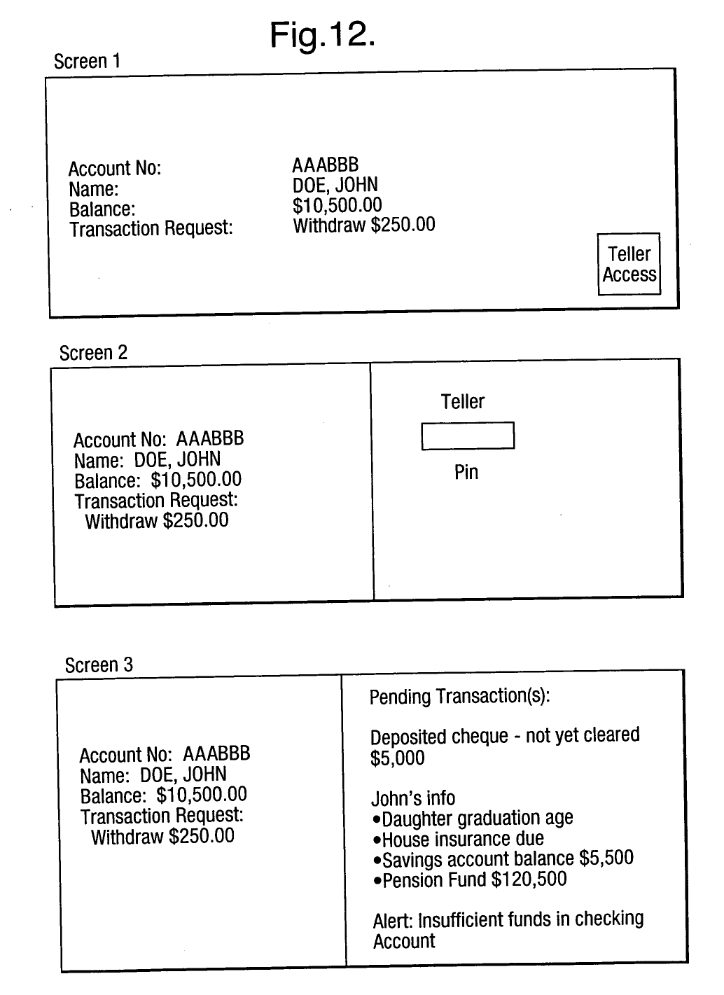

FIG. 12 shows an example of what could be displayed in the teller-assist mode. Screen 1 shows the Teller Access touch screen button that is provided on the display when the customer is using the machine. When the Teller Access button is pressed, Screen 2 is displayed through which the teller can input the teller's PIN. Once the correct PIN is entered, Screen 3 is displayed. In the FIG. 12 example, Screen 3 includes the customer and teller displays somewhat similar to those of FIGS. 9 and 10, respectively, although other displays are possible. According to one embodiment, when the customer presses the Teller Access button in Screen 1, a roaming teller in the bank is alerted to the need for assistance at the particular customer station. This can be performed by wirelessly transmitting a signal to the roaming teller. The roaming teller could wear an earpiece that receives the signal, which also could include information on the customer such that the teller is briefed about the customer as the teller traverses the bank to reach the particular customer station.

When in the fourth mode, with the teller and customer viewing the same display, it is likely that the customer can view any alerts provided to the teller. If the bank does not want the customer to view such alerts, the alerts could be provided to the teller as audible alerts through an earpiece worn by the teller. The earpiece could receive signals from the system TCX1 in a wireless fashion.

A switch could be provided on the machine TCX1 in order to switch the machine between the various modes described above. Alternatively, a touch screen button could be provided on either of the displays D1 and/or D2 by which a bank employee could change the mode of the machine. When the mode switching button is pressed by the bank employee, a new screen requiring input of a password or a PIN number would be displayed. Once an appropriate password or PIN number is entered, another screen would be displayed in order to enable the bank employee to select between the various possible modes.

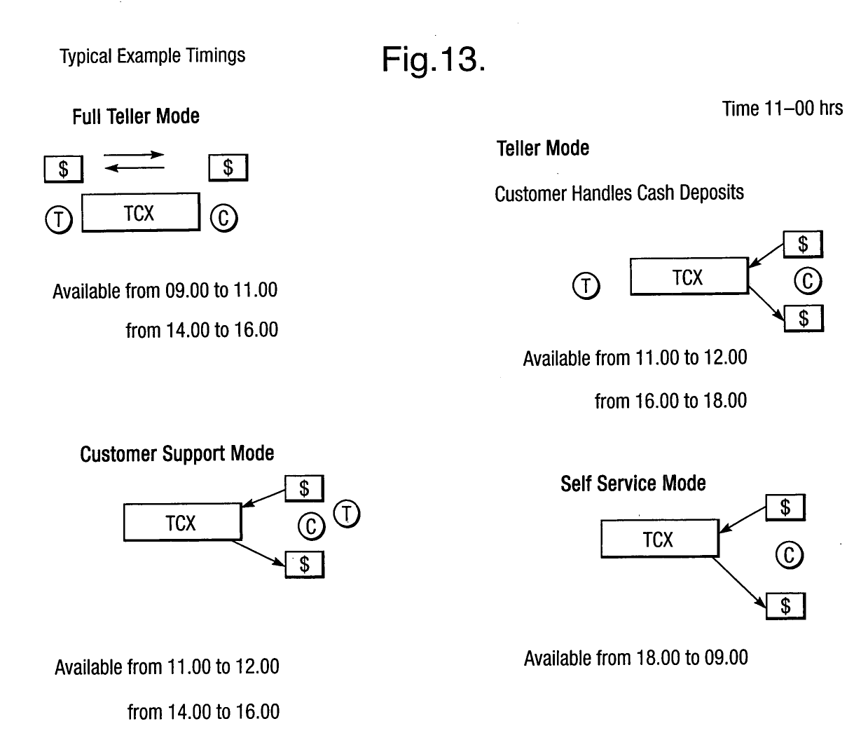

In addition, time of day and day of week rules could be set in the system in order to automatically switch the TCX between the different modes of operation, and to ensure that only one mode is operating at a given time. Such settings could be input through a keyboard and/or touch screen. FIG. 13 shows some examples of possible automatic mode selections. In FIG. 13, the full teller (first) mode operates between 9 and 11 am and between 2 and 4 pm, the teller (second) mode operates between 11 am and noon and between 4 and 6 pm, the self-service (third) mode operates between 6 pm and 9 am, and the customer support (fourth) mode operates on at least some machines between 11 am and noon and between 2 and 4 pm.

In addition, a supervisor could override the timing settings by requesting a particular mode instantly, and the machine could revert to the time-based setting when instructed to do so. Also, a wireless controller could be used to instruct which mode each TCX should be operating in regardless of the time of day. Such control could be made based on the number of customers and tellers at a given time period.

Thus, a bank could purchase a single machine like machine TCX1 and then use that machine in any of the four modes described above. This would enable the bank to have more flexibility in the services that it offers to customers. For example, if a plurality of machines like the machine TCX1 were provided in a teller counter, a plurality of teller stations would be available. For example, each of the machines could be operated in the above-described second mode in which display D1 is a customer display and display D2 is a teller display. If, however, a teller was not available for each of the machines TCX1, then the machines for which no teller is available could be placed into the third mode such that the machine operates as an ATM (display D2 would no longer be used and the set of instructions, etc., for operation in the self-service (ATM) mode would be provided on display D1). This can result in a reduction in the length of lines in the bank when, for example, all teller stations are not manned by a teller.

If the machine was provided at a location near the entrance/exit of the bank, then the machine could operate, for example, in the above-described second mode (teller station with dispensing and possibly receiving of cash to/from a customer) during business hours, and function in the third mode (like an ATM) after hours. For example, if the bank office is located in a mall, the machine could be placed so that the end having the display screen D2 (which would function as a teller display screen in the second mode) is located inside the perimeter of the bank, while the other end (having the display screen D1 functioning as a customer display and at least the cash dispenser CD1) projects into the mall area outside of the bank perimeter. During business hours, the machine could operate in the second mode. After business hours, when the barrier or gate separating the bank from the common mall area is closed, that barrier could include a hole that fits over the machine TCX1 such that the customer side (with display D1 and at least cash dispenser CD1) extends into the mall area, and the system could be placed in the third mode. The machine could then be used as an ATM.

If the system was movable, it could be located within the bank during normal business hours (for example, 9 am-5 pm) and operated in any of the four modes, and then moved to a position where at least the display D1 and cash dispenser CD1 are accessible from outside of the bank during non-business hours. For example, the system could role on tracks between the two different locations. This set up enables the system to be used 24 hours per day, and allows the bank to provide ATM-like services without purchasing a dedicated ATM.

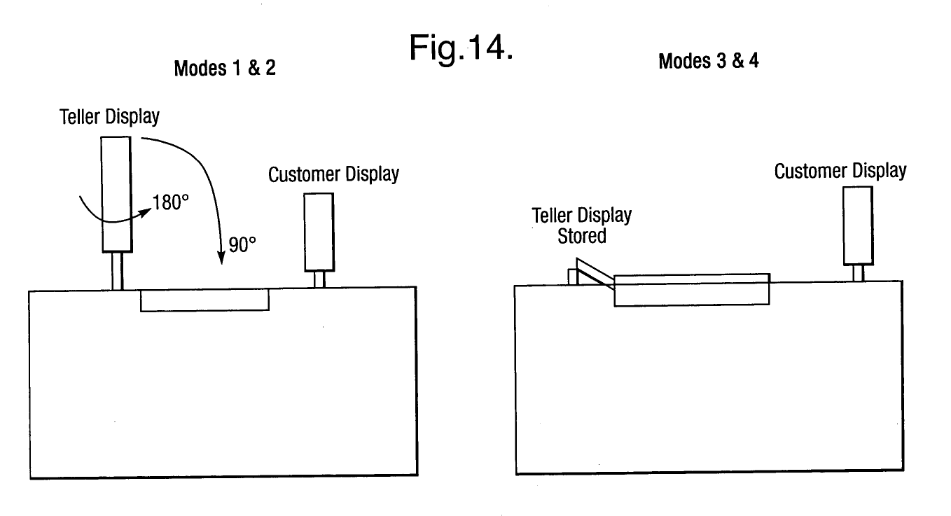

In addition, because the display D2 is not used in all modes of operation (it is not used in the third and fourth modes), that display could be retractable into the machine (for example, when the machine is operating in the third and/or fourth modes) or detachable from the machine during those modes. In addition, moving the display D2 into or out of the machine (or attaching/detaching the display D2 with respect to the machine) could trigger changing of the modes. For example, detaching the display D2 from the machine could automatically cause the machine to operate in either the third or the fourth mode. Conversely, attaching the display D2 to the machine could automatically cause the machine to operate in either the first or second mode. Retracting the display D2 into the machine or withdrawing the display D2 from the machine also could cause such switching of modes. FIG. 14 shows one example of an arrangement in which one of the displays (the teller display) is retractable. When the third and fourth modes are selected, the teller display swivels and is loaded flat and locked into a position within a cutout in the top surface of the TCX such that the screen faces downward. The movement of the display can be performed by electric motors controlled by the system's CPU and its software commands, although manually movable embodiments (without electric motors) also are possible.

Another embodiment having a single display screen is shown in FIGS. 3 and 4. In this embodiment, the machine is a teller cash dispenser TCD2 having a cash dispensing portion CD2. A drop box could be provided on either end of the machine in order to receive deposits (for example located in an envelope having the customer's account information). Components for handling coins and/or checks also can be provided.

The machine TCD2 has a single display D3 that is rotatable between a first position shown in FIG. 3 in which the display portion of the display D3 faces the end of the machine having the cash dispenser CD2, and a second position shown in FIG. 4 in which the display portion of the display D3 faces away from the cash dispenser CD2. The display is rotatable through 180 degrees as illustrated by the curved arrow in FIG. 3. The display rotates about a display support 55 that rotatably attaches the display D3 to the body of the machine TCD2. The portion of the support 55 located within the body TCD2 can operate a switch as it is rotated in order to switch the machine between the different modes.

For example, when the display D3 has the orientation illustrated in FIG. 3, in which the display portion of the display faces the cash dispenser CD2, the machine can automatically be placed into the third (self service) mode so that it functions like an ATM. In addition, if the customer desires assistance, an available teller could, by pressing a button on the touch screen and entering the teller's PIN or password or by swiping the teller's ID card, place the machine into the fourth mode in which the teller can assist the customer (i.e., change the mode of the machine from the self-service mode to the teller assist mode).

When the display D3 is placed in the orientation shown in FIG. 4, such that the display portion of the display D3 faces away from the cash dispenser CD2, the machine automatically switches to the second mode in which a teller operates the machine. In this mode, cash is dispensed directly to the customer by the cash dispenser CD2. However, preferably the teller must enter the teller's PIN or password or swipe the teller's card in order to process transactions.

When the system is in the orientation shown in FIG. 3, such that the system is operating in the third (self-service) mode, the system can be designed so that the display D3 displays general promotional material regarding the bank while no customer is using the machine. The system can include a proximity sensor that is capable of sensing when a customer is very close to the system such that it can be assumed that the customer desires to use the system in the self-service mode. FIG. 5 shows the zone sensed by the proximity sensor in the system set-up of FIG. 3. When sensed by the proximity sensor, the display D3 will display an initial screen (see, for example, FIG. 11) for the customer to use in accessing the customer's account in the third mode. For example, the initial screen could request the user to press a touch screen button if the customer desires to perform a transaction, and then a plurality of selections can be presented to the customer as possible translations. Such transactions include: make a deposit, make a withdrawal, transfer funds, make a loan payment, pay utility bills, etc. When the display D3 is rotated from the position shown in FIG. 3 to the position shown in FIG. 4, the switch within the system is toggled to a different position such that the teller mode is activated. When the teller mode is activated, the screen displayed over the display D3 changes to a screen for allowing the teller to access the system. That screen could request the teller to input the teller ID and/or PIN, or request the teller to swipe the teller's ID card, for example.

Thus, in the embodiment of FIGS. 3 and 4, rotating the display D3 causes the system TCD2 to change modes and causes the screens that are displayed on the display D3 to change. Switching the modes in the other embodiments described previously and hereafter also can cause the screens that are displayed over the display to change.

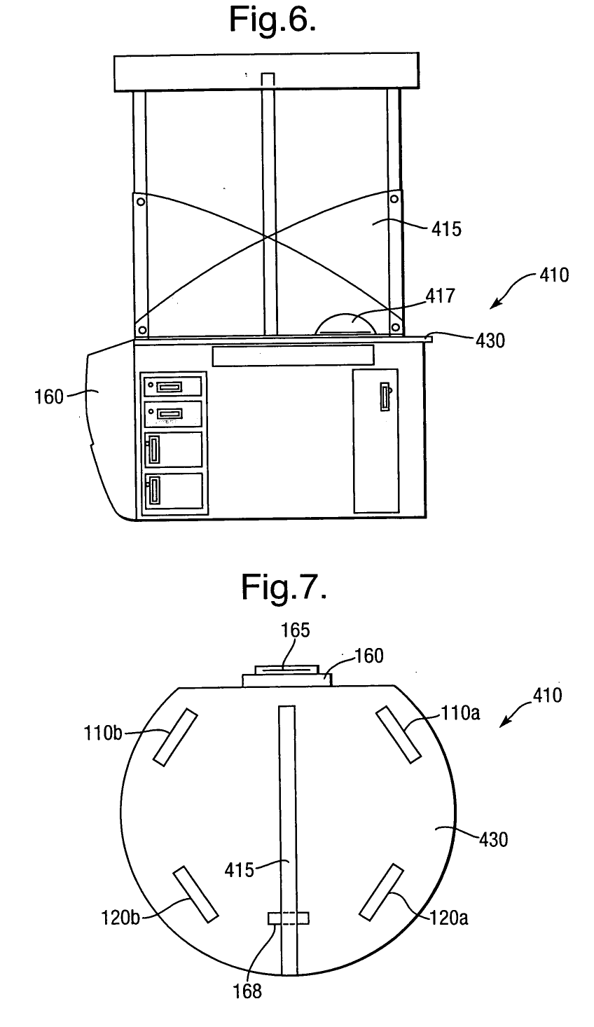

FIGS. 6 and 7 are views of a dual teller podium/tower 410, with FIG. 6 being a side view and FIG. 7 being a top view. The dual teller podium/tower includes a single cash dispenser or cash recycler that is shared by two tellers, such that two customers can be serviced at one time. In the embodiment of FIGS. 6 and 7, the dual teller podium/tower includes a TCD 160 having a drop box 165 and a cash dispensing device 168. The cash dispensing device 168 dispenses cash to the customers. In particular, the dual teller podium/tower includes first and second teller displays 110a and 110b and first and second customer displays 120a and 120b. In addition, a partition 415 is provided between the first teller station, which includes teller display 110a and customer display 120a, and the second teller station, which includes teller display 110b and customer display 120b. The partition 415 includes an arc-shaped aperture 417 located above the cash dispensing device 168. The dual teller podium/tower 410 includes a horizontal counter 430 on which the displays 110a, 110b, 120a and 120b are provided.

The system of FIGS. 6 and 7 is operable in three modes: a first mode in which the teller controls the system, but cash is dispensed directly to the customer; a second mode in which the system operates as a self-service device (like an ATM); and a third mode in which the device is a self-service device with teller assist. In the second and third modes, the teller displays 110a and 110b are not operative.

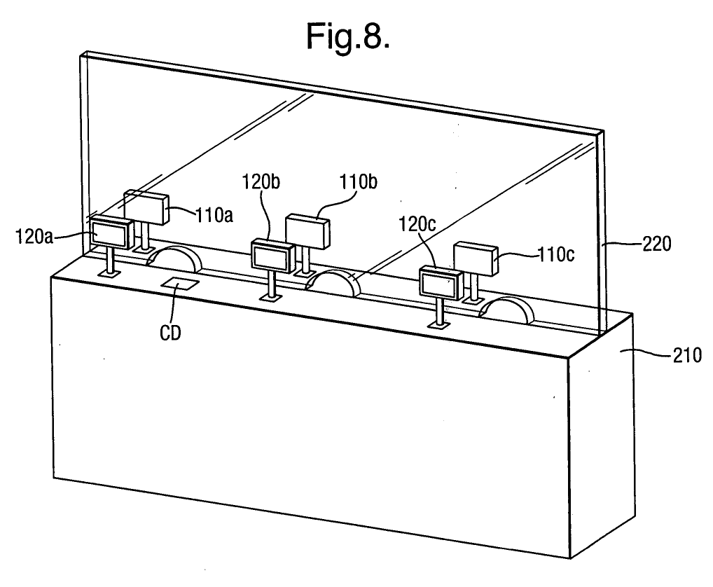

FIG. 8 shows an arrangement in which the teller stations are provided at a typical teller counter in which a counter 210 and partition 220 separate a teller area from a customer area. The teller area is located on the side having teller displays 110a, 110b and 110c, whereas the customer side is the side having customer displays 120a, 120b and 120c. A teller cash dispenser is provided inside the counter 210, and includes a cash dispensing device CD located on the customer side of the partition 220. Alternatively, a TCR could be provided within the counter, and it could be designed to dispense cash to the customer and receive cash from the customer or dispense cash to the customer and receive cash from the teller.

The FIG. 8 embodiment functions similar to the embodiment described above with respect to FIGS. 6 and 7, and can be switched between three different modes of operation (the teller mode with cash dispense to customer, the self-service mode and the self-service mode with teller assist).

When the systems described above are operating in the self-service mode, the displays could display a message indicating that it is a self-service device, and encouraging customers to use it if desired. In addition, the bank could have a roaming teller that greets customers entering the bank and directs those customers to the appropriate station depending on whether the customer requires teller assistance or can use a system operating in the self-service mode. That roaming teller also could assist customers in the self-service mode with teller assist.

The dual station embodiments also could include a movable partition associated with the cash dispensing device (168 or CD) so that the cash is directed toward the appropriate customer.

Because a TCR receives cash in addition to dispensing cash, a TCR can become filled, and thus require skimming of cash from it so that it can continue to be used. On the other hand, TCDs, which only dispense cash, can become empty and require replenishment. Typically, if a TCR becomes full, it is taken off line so that its roll storage modules can be emptied or removed and replaced with non-full roll storage modules). Similarly, a TCD typically is taken off line so that its cash-holding cartridges can be replaced with full cartridges.

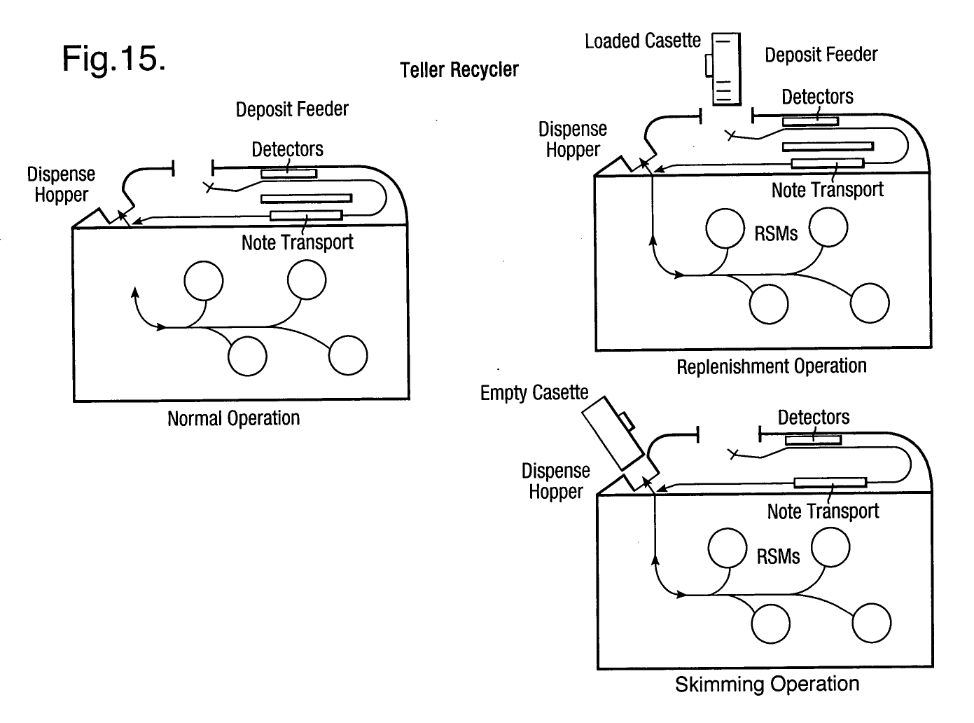

However, by providing a TCR with one or more additional cassettes and dedicated cassette input/output ports, a cassette could be loaded into the additional input/output port in order to skim notes from the full or nearly-full roll storage modules of the TCR. Conversely, a cassette could be placed into the additional input/output port in order to dispense notes to roll storage modules that are empty or nearly-empty. A TCD also could be provided with an additional cassette and input/output port so that a full cassette could be placed into the additional input/output port in order to supply notes to any empty or nearly-empty cartridges within the TCD. FIG. 15 shows one example of a TCR that can perform a replenishment operation and a skimming operation. For replenishment, the loaded cassette is docked into the deposit feeder and the notes are taken into the machine and loaded into its Role Storage Modules in the same way as if handling a deposit. For skimming, an empty cassette is docked onto the dispense hopper and notes are delivered to the hopper as if it was a customer dispense, but are further manipulated so as to be stacked into the docked cassette.

By providing a bank with one or more TCRs and one or more TCDs with such additional cassettes and input/output ports, the TCR could be used to supply bills to the TCDs (or other TCRs) in the bank such that it would not be necessary for the bank to include a back office for filling and emptying cassettes taken from full TCRs or for filling up empty TCR roll storage modules or TCD cassettes.

Another option for avoiding taking a TCR off line to remove excess funds would be to provide the TCR with a modified bander that makes bundles of notes from the full roll storage modules, and then deposits those bundles into a secure area within the TCR that can only be accessed by an authorized person.

What is claimed is:

1. A financial transactions processing system comprising:
a note dispenser that includes a store of notes to be dispensed to customers;
a display; and
a controller that is coupled to the note dispenser and to the display, and that controls the note dispenser and the display, the controller controlling the financial transactions processing system to be selectively operable in a plurality of different modes.

2. The financial transactions processing system of claim 1, wherein a first one of the modes is a teller mode in which a teller controls the system, and a second one of the modes is a self-service mode in which the customer controls the system.

3. The financial transactions processing system of claim 2, wherein a third one of the modes is a self-service-teller-assist mode in which the teller can help the customer perform self service operations.

4. The financial transactions processing system of claim 3, wherein the first mode is a teller mode in which notes are dispensed directly to the teller, and wherein a fourth one of the modes is a teller mode in which the notes are dispensed directly to the customer.

5. The financial transactions processing system of claim 2, wherein the first mode is a teller mode in which notes are dispensed directly to the teller, and wherein a third one of the modes is a teller mode in which the notes are dispensed directly to the customer.

6. The financial transactions processing system of claim 1, wherein a first one of the modes is a teller mode in which a teller controls the system and notes are dispensed directly to the teller, and a second one of the modes is a teller mode in which the teller controls the system and the notes are dispensed directly to the customer.

7. The financial transactions processing system of claim 1, wherein the controller automatically switches between the modes based on movement of the display.

8. The financial transactions processing system of claim 7, further comprising a switch that causes the controller to switch between the modes based on a state of the switch, and wherein rotation of the display changes the state of the switch.

9. The financial transactions processing system of claim 2, wherein the controller automatically switches between the modes based on movement of the display.

10. The financial transactions processing system of claim 9, further comprising a switch that causes the controller to switch between the modes based on a state of the switch, and wherein rotation of the display changes the state of the switch.

11. The financial transactions processing system of claim 1, wherein a first one of the modes is a teller mode in which the display displays a screen that is to be used by a teller, and a second one of the modes is a customer mode in which the display displays at least one screens to be used by the customer.

12. The financial transactions processing system of claim 11, wherein the at least one screen to be used by the customer includes instructions for the customer to use the system.

13. The financial transactions processing system of claim 12, wherein the at least one screen to be used by the customer includes a screen that provides promotional material.

14. The financial transactions processing system of claim 11, wherein the at least one screen to be used by the customer includes a screen that provides promotional material.

15. The financial transactions processing system of claim 1, further comprising a switch that causes the controller to switch between the modes based on a state of the switch.

16. The financial transactions processing system of claim 15, wherein the switch is displayed on the display, which includes a touch screen.

17. The financial transactions processing system of claim 15, wherein the switch is a mechanical switch.

18. The financial transactions processing system of claim 1, wherein the note dispenser is a note recycler that also includes a note counting and denominating portion.

19. The financial transactions processing system of claim 1, wherein the system is provided at an in-line teller counter.

20. The financial transactions processing system of claim 1, wherein the system is provided at a stand-alone podium around which the teller and the customer can walk.

21. The financial transactions processing system of claim 1, further comprising a second display, wherein a first screen is displayed on the first display and a second screen is displayed on the second display when in a first one of the modes, and the first screen is displayed on the second display and the second screen is displayed on the first display when in a second one of the modes.

22. The financial transactions processing system of claim 1, further comprising a second display, wherein the first and second displays are operative when in a first one of the modes, and only one of the first and second displays is operative when in a second one of the modes.
